(19) United States
(12) Patent Application Publication
(10) Pub. No.: US 2013/0074181 A1
(43) Pub. Date: Mar. 21, 2013

(54) Auto Migration of Services Within a Virtual Data Center

(71) Applicant: Sumeet Singh, Saratoga, CA (US)

(72) Inventor: Sumeet Singh, Saratoga, CA (US)

(73) Assignee: CISCO TECHNOLOGY, INC., San Jose, CA (US)

(21) Appl. No.: 13/235,818

(22) Filed: Sep. 19, 2011

(51) Int. Cl. G06F 11/00

(52) U.S. Cl. 726/22

(57) ABSTRACT

Techniques are provided herein for detecting that virtual data center services provided to one of at least two customers are being subjected to an attack, wherein the virtual data center services are provided to the least two customers using a same first set of physical servers via a first network element such as a physical access switch, and responsive to detecting that virtual data center services provided to the one of the at least two customers are being subjected to an attack (e.g., a virus or denial of service attack), the technique causes the virtual data center services provided to the one of the at least two customers to be migrated to, e.g., instantiated on, a second set of physical servers that is not accessible via the first network element.

### TECHNICAL FIELD

The present disclosure relates to cloud computing and related data centers.

### BACKGROUND

“Cloud computing” can be defined as Internet-based computing in which shared resources, software and information are provided to client or user computers or other devices on-demand from a pool of resources that are communicatively available via the Internet. Cloud computing is envisioned as a way to democratize access to resources and services, letting users efficiently purchase as many resources as they need and/or can afford. A significant component of cloud computing implementations is the “data center.” A data center is a facility used to house computer systems and associated components, such as telecommunications and storage systems. It generally includes redundant or backup power supplies, redundant data communications connections, environmental controls (e.g., air conditioning, fire suppression) and security devices. A data center provides compute, network and storage functionality supported by a variety of physical elements or hardware devices including, but not limited to, compute, network and storage devices that are assembled, connected and configured to provide the services that a given user might want via the “cloud.”

As the demand for cloud services has continued to grow, the notion of a “virtual data center” has emerged. With a virtual data center, rather than dedicating a collection of specific hardware devices to a particular end user, the end user receives services from, perhaps, a dynamically changing collection of hardware devices, or even a portion or parts of given hardware devices that are shared, unknowingly, by another end user. From the end user's perspective, it may appear as though specific hardware has been dedicated for the user's requested services, but in a virtualized environment this would not be the case.

### BRIEF DESCRIPTION OF THE DRAWINGS

FIG. 1 is an example block diagram of a data center including an attack detection and migration trigger module for causing attacked services to be migrated.

FIG. 2 is an example implementation of the attack detection and migration trigger module.

FIG. 3 is an example of a generalized flow chart depicting operations performed by the attack detection and migration trigger module.

FIG. 4 shows a simplified version of FIG. 1 including migration of services from one POD of a data center to another POD of the data center.

FIG. 5 is an example of a generalized flow chart depicting other operations performed by the attack detection and migration trigger module.

### DESCRIPTION OF EXAMPLE EMBODIMENTS

Overview

In one embodiment a methodology includes providing virtual data center services to a plurality of customers using a physical data center. The physical data center comprises physical servers and a first network element that provides connectivity to the physical servers, wherein the virtual data center services are provided to at least two customers of the plurality of customers using a same first set of physical servers via the first network element. The virtual data center services are monitored and it is detected that the virtual data center services provided to one of the at least two customers are being subjected to an attack that, e.g., results in an overuse of physical resources that might impact other customers or users. Responsive to that detection, the methodology is configured to cause the virtual data center services provided to the one of the at least two customers to be migrated to a second set of physical servers that is not accessible via the first network node. In this way, while one customer might be subjected to some type of attack or virus, the impact to virtual data center services being provided to another customer via a same network element (e.g., an access switch) can be diminished or eliminated. In one possible embodiment, migration of services is initiated only when it is determined that the attack or virus is impacting the level of service for services not being directly subjected to the attack.

### Example Embodiments

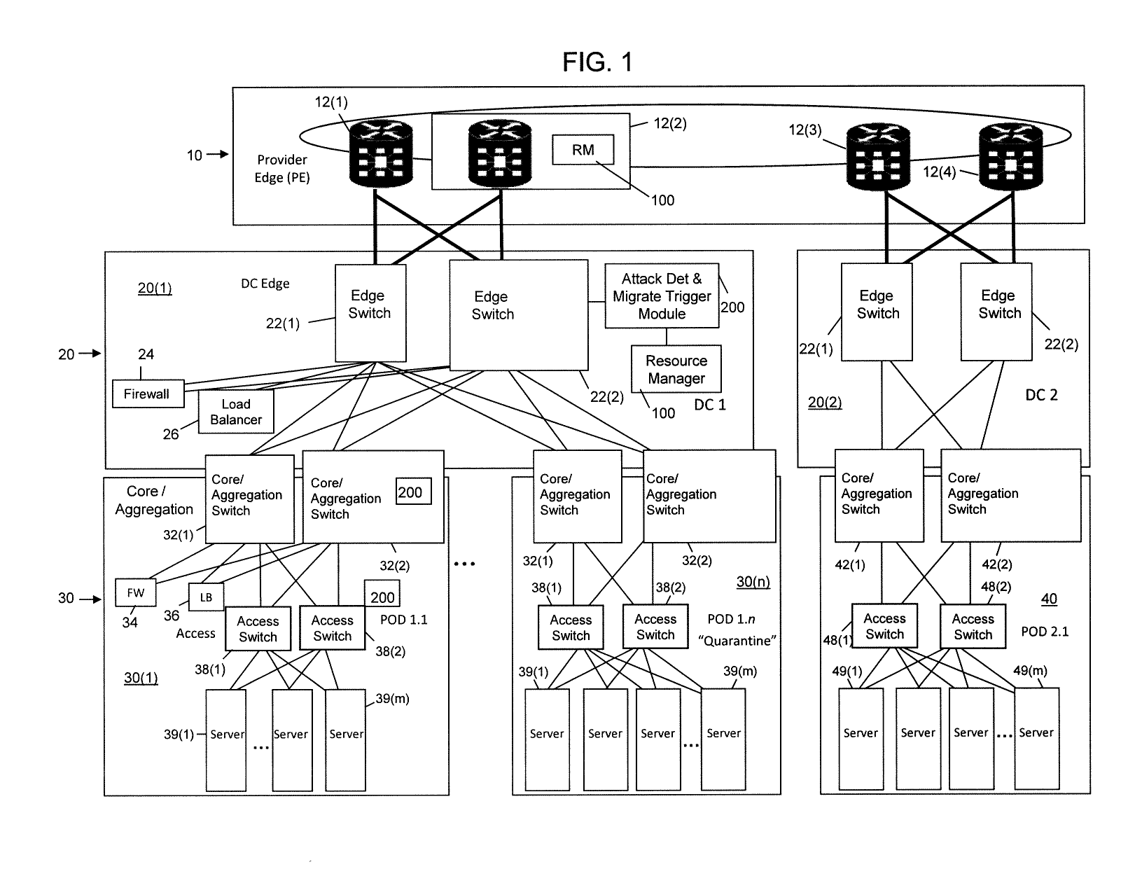

Referring first to FIG. 1, an example of a cloud computing system or environment including multiple data centers is depicted. The system is configured in a hierarchical fashion to respond to cloud computing service requests. In one possible implementation, the system is operated by a service provider, such as a telecommunications company that serves a plurality of customers where each customer receives virtual data center services.

As shown, the system comprises a plurality of hierarchical levels. The highest level is a network level 10. The next highest level is a data center (DC) level 20. Beneath the data center level 20 is a POD level 30. While FIG. 1 shows three levels in the hierarchy, this is only an example, as there may be additional levels. There are elements, e.g., hardware devices or components, in each hierarchical level. The elements may comprise switches, routers, load balancers, firewalls, servers, network appliances or any hardware device that is involved in providing a function to support a virtualized environment. In one possible implementation of the system shown in FIG. 1, requests for data center services are received from end users connected to network level 10 and those services are provided by one or more elements in the system.

The network level 10 connects multiple different data centers at the data center level 20, e.g., data center 20(1) labeled as “DC 1” and data center 20(2) labeled as “DC 2,” and subsets of the data centers called “PODs” that are centered on aggregation switches within the data center. Again, the number of levels shown in FIG. 1 is an example. It is possible to deploy an arbitrary number of levels of hierarchy, possibly with different definitions than in this example. The hierarchy may follow the physical topology of the network but it is not required.

In the network level 10, there are Provider Edge (PE) devices that perform routing and switching functions. FIG. 1 shows four PE devices 12(1)-42(4) as an example. At the data center level 20, there are edge switches, firewalls and load balancers. For example, in a first data center 20(1) labeled “DC 1” in FIG. 1, there are edge switches 22(1) and 22(2), a firewall device 24 and a load balancer device 26. The PE devices 12(1) and 12(2) in the network level 10 are each connected to the edge switches 22(1) and 22(2). Also shown in one of the PE devices 12(2) is a Resource Manager 100, another one of which is shown at the data center level 20 in data center 20(1). The Resource Manager (RM) 100 is configured to allocate hardware within a data center or data centers to perform the services that have been requested. Specifically, the RM 100 maintains a table, mapping, list or other form of information management to correlate specific hardware devices and the virtualized services that those hardware devices will and do support. For example, an end user, customer or “tenant” may want a web server to be operated. Resource Manager 100 is configured to allocate the one or more servers 39 that will instantiate the web server desired by the customer. From the customer's perspective, a web server may be operating. From the Resource Manager's perspective, multiple virtual machines may have been instantiated to support the “single” web server requested by the customer.

Although shown as two separate components in the PE device 12(2) and data center 20(1), Resource Manager 100 may be implemented as a single component and may be hosted in other networking elements in the data center. In another form, the Resource Manager 100 may be distributed across multiple devices in the system shown in FIG. 1.

As further shown in FIG. 1, the edge switches 22(1) and 22(2) are each connected to the firewall device 24 and load balancer device 26. Similarly, in data center 20(2), there are edge switches 22(1) and 22(2), and also a firewall device and a load balancer device. The firewall and load balancer devices in data center 20(2) are not shown in FIG. 1 for simplicity.

At the POD level 30, there are core/aggregation switches, firewalls, load balancers and web/application servers in each POD. The functions of the firewalls, load balancers, etc., may be hosted in a physical chassis or they may be hosted by a virtual machine executed on a computing element, e.g., a server 39, in the POD level 30. PODs 30(1)-30(n), labeled “POD 1.1”-“POD 1.n”, are connected to data center 20(1) and POD 40 is connected to data center 20(2). Thus, PODs 30(1)-30(n) may be viewed as different processing domains with respect to the data center 20(1), and the data center service rendering engine 200 in the edge switch 22(2) may select which one (or more) of a plurality of processing domains in the POD level to be used for aspects of a cloud service request that the data center service rendering engine 200 receives. Data center 20(2) cannot select one of the PODs 30(1)-30(n) because they are in different processing domains, but data center 20(2) can select POD 40. In this regard, POD 1.n may also be designated as a “Quarantine” POD, which may be used, as discussed more fully below, as a temporary or permanent repository for virtual data center services that may be subjected to some form of attack (e.g., a virus or denial of service attack) and which, as a result, may be impacting virtual data center services that are being provided to other customers or tenants of the data center.

In each of PODs 30(1)-30(n), there are core/aggregation switches 32(1) and 32(2), one or more firewall (FW) devices 34, one or more load balancer (LB) devices 36, access switches 38(1) and 38(2) (or network elemens) and servers 39(1)-39(m). The firewall and load balancers are not shown in POD 30(n) for simplicity. Each server 39(1)-39(m) runs one or more virtual machine processes, i.e., virtual servers, which support instantiations of virtual data centers. Similarly, in POD 40 there are core/aggregation switches 42(1) and 42(2), access switches 48(1) and 48(2) and servers 49(1)-49(m). POD 40 also includes one or more firewalls and load balancers but they are omitted in FIG. 1 for simplicity.

When an end user request for cloud computing services that is supportable by the data center is received, that request may be handled by Resource Manager 100 to allocate the specific hardware devices that will provide the services requested. Example services include, e.g., web server services, database services, and compute services (e.g., data sorting, data processing or data mining). As mentioned, these services may be instantiated on one or more of the servers 39 in the form of virtual machines. Thus, from the perspective of a given customer or tenant, it appears as though, for example, a web server has been brought on-line. However, that “web server” may in fact be spread out or distributed across one or more multiple servers 39, and that or those servers hosting the virtual web server may simultaneously be hosting other data center services for other customers or tenants.

With the architecture as shown in FIG. 1 and instantiation of virtual data services described above in mind, an issue can arise when a particular customer for whom virtual data center services are being provided comes under attack. In the case of, e.g., a denial of service attack in which a web server (in this case a virtualized web server) is accessed automatically by an unexpectedly large number of computers from outside of the physical data center, it is possible that not only will that customer's virtualized web services be impacted, but it is quite possible that other customers' virtualized services (web or other services) that are sharing the same physical infrastructure as the attacked virtualized web server might also be detrimentally impacted. That physical infrastructure may include, among other things, one or more routers, switches, load balancers, firewalls, compute, memory and network capabilities.

As a specific example, the impact of such an attack might be experienced directly by the servers 39, in the form of, e.g., diminished available compute or memory resources, within one or more PODs 30.

Considering the same example, traffic destined for a given virtualized web server will enter a data center edge switch 22, be passed to a core/aggregation switch, and traverse an access switch 38 to finally reach a target server 39. If one or more servers hosting a virtualized web server come under a denial of service attack, then the Internet traffic travelling along the described path (edge-core/aggregation/access switch) will substantially increase thus increasing the use of available input/output bandwidth along that path. Such an increase in traffic might also detrimentally impact the input/output bandwidth of other customers' virtualized services whose traffic also traverses the same path. Input/output bandwidth can also be affected by any increased load or use of load balancers, firewalls, hardware accelerated network services, etc. That is, any given, e.g., load balancer or firewall can support a predetermined number of sessions, and if one virtualized service happens to come under attack, that service could consume an increased number of sessions resulting in other virtualized services to not operate effectively.

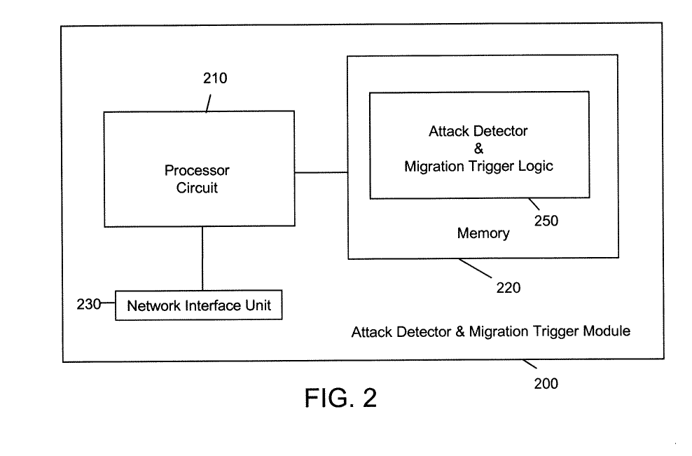

In accordance with one possible embodiment, an Attack Detector and Migration Trigger Module 200 is deployed in the hierarchy shown in FIG. 1. In one embodiment, Attack Detector and Migration Trigger Module 200 may be deployed as part of or in communication with an edge switch 22, as part of or in communication with a core aggregation switch 32 or as part of or in communication with an access switch 38. The functionality of Attack Detector and Migration Trigger Module 200, implemented with Attack Detector and Migration Trigger Logic 250 (shown in FIG. 2), may also be distributed among multiple hardware devices. As further shown, Attack Detector and Migration Trigger Module 200 is in communication with Resource Manager 100. As will be explained more fully below, one function of Attack Detector and Migration Trigger Module 200 is to detect that virtual services for a given customer are being subjected to an attack and, especially where such an attack is also detrimentally impacting other virtual services being provided to other customers or tenants that might be sharing physical resources with the attacked virtualized services, to trigger the Resource Manager 100 to force the virtual services under attack to be migrated to an isolated area of the data center from which they may still be operated.

FIG. 2 shows an example implementation of the Attack Detector and Migration Trigger Module 200. Module 200 comprises a processor 210, memory 220 and network interface device 230. The memory 220 stores instructions in the form of Attack Detector and Migration Trigger Logic 250 for the Attack Detector and Migration Trigger Module 200. The network interface device 230 is configured to perform communications (transmit and receive) over a network in order to communicate with, e.g., edge switch 22, core/aggregation switch 32 and/or access switch 38, as well as Resource Manager 100.

The memory 220 is, for example, random access memory (RAM), but may comprise electrically erasable programmable read only memory (EEPROM) or other computer-readable memory in which computer software may be stored or encoded for execution by the processor 210. The processor, e.g., a processor circuit, 210 is configured to execute instructions stored in associated memories for carrying out the techniques described herein. In particular, the processor 210 is configured to execute program logic instructions (i.e., software) stored or encoded in memory, namely Attack Detector and Migration Trigger Logic 250.

The operations of processors 210 may be implemented by logic encoded in one or more tangible media (e.g., embedded logic such as an application specific integrated circuit, digital signal processor instructions, software that is executed by a processor, etc.). The functionality of Attack Detector and Migration Trigger Module 200 may take any of a variety of forms, so as to be encoded in one or more tangible media for execution, such as fixed logic or programmable logic (e.g. software/computer instructions executed by a processor) and the processor 210 may be an application specific integrated circuit (ASIC) that comprises fixed digital logic, or a combination thereof. For example, the processor 210 may be embodied by digital logic gates in a fixed or programmable digital logic integrated circuit, which digital logic gates are configured to perform the operations of the Attack Detector and Migration Trigger Module 200. In one form, the functionality of Attack Detector and Migration Trigger Module 200 is embodied in a processor or computer-readable memory medium (memory 220) that is encoded with instructions for execution by a processor (e.g., processor 210) that, when executed by the processor, are operable to cause the processor to perform the operations described herein in connection with Attack Detector and Migration Trigger Module 200.

Attack Detector and Migration Trigger Logic 250, i.e., the functionality embodied in Attack Detector and Migration Trigger Module 200, is configured to detect some sort of attack. For example, Logic 250 may be configured to detect a denial of service attack launched against a web service. Attack Detector and Migration Trigger Logic 250 may also be configured as a general purpose anti-virus application that can monitor the virtual services being provided by a given virtual data center. Indeed, since Attack Detector and Migration Trigger Module 200 may be deployed with or in communication with, e.g., an access switch 38, Attack Detector and Migration Trigger Module 200 can monitor the traffic passing to the plurality of virtual machines instantiated on the plurality of physical servers 39. In one possible implementation, tracking and/or monitoring of selected virtual services may be implemented by filtering traffic based on virtual local area network (VLAN) tags in Ethernet frames.

When an anomaly, e.g., a virus, unexpectedly increased I/O activity, or a denial of service attack, is detected, a second function of the Attack Detector and Migration Trigger Module 200 is to communicate with, e.g., Resource Manager 100 to cause or trigger affected virtual services to be migrated to a different part of the data center, where the affected services can no longer detrimentally impact, e.g., cause inadvertent denial of service to, other virtual services that have been instantiated on behalf of other customers or tenants.

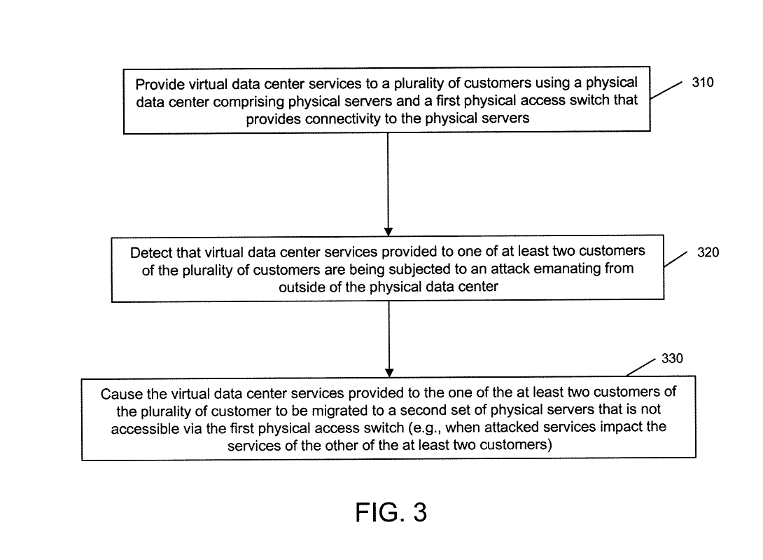

FIG. 3 is a flowchart depicting example operations in accordance with one possible implementation. At 310, the methodology is configured to provide virtual data center services to a plurality of customers using a physical data center comprising physical servers and a first physical access switch that provides connectivity to the physical servers. In one possible state of providing such services, the virtual data center services are provided to at least two customers of the plurality of customers using a same first set of physical servers via the first physical access switch. For example, and with reference to FIG. 1, virtual data center services may be instantiated using server 39(1) via access switch 38(1) in POD 1.1. It is noted that a set of physical services also includes the possibility of a set of one, i.e., a single server.

At 320, the methodology provides for detecting that virtual data center services provided to one of the at least two customers of the plurality of customers are being subjected to an attack emanating from outside of the physical data center. Such detecting may be performed by Attack Detection and Migration Trigger Logic 250 operating on access switch 38(1) or some other hardware device from which detection can be effected.

At 330, responsive to detecting that virtual data center services provided to the one of the at least two customers of the plurality of customers are being subjected to an attack emanating from outside of the physical data center, the methodology provides for causing or triggering the virtual data center services provided to the one of the at least two customers of the plurality of customer to be migrated to, e.g., instantiated on, a second set of physical servers that is not accessible via the first physical access switch. This migration trigger may be initiated by Attack Detection and Migration Trigger Logic 250. Again with reference to FIG. 1, the affected virtual data center services may be migrated to POD 1.n that is designated as a “quarantine” POD. By re-instantiating the attacked services in such a quarantine POD, the virtualized services remaining in, e.g., POD 1.1 will no longer be detrimentally impacted by, e.g., the overuse of resources by the migrated services.

It is noted that the attack may emanate from outside of the physical data center and be detected either as a result of the traffic along the edge switch/core/aggregation switch/access switch path or as a function of how the attack manifests itself within one or more virtual machines subjected to the attack.

As mentioned, once detection of an anomaly is detected in virtual services being provided, the affected services may be migrated to, e.g., a quarantine area or some other isolated part of the data center. The Resource Manager 100 may be configured to effect the desired migration in response to, e.g., an instruction received from Attack Detection and Migration Trigger Logic 250. In one embodiment, the Resource Manager 100 effects a migration such that the affected virtual data center services are migrated to a second set of physical servers that is not accessible via the first physical access switch. Referring to FIG. 1, because access switches serve only those servers directly beneath them in the system hierarchy, when the affected services are migrated to, e.g., quarantine POD 1.n, the prior access switch is no longer in the communication pathway for the affected virtual services.

Noted earlier was the ability to track individual virtualized services for purposes of attack detection using, e.g., a VLAN tag. It may also be possible to track individual virtualized services using assigned quality of service (QoS) levels. In many implementations, QoS levels are limited to an 8-bit value. Consequently, at most 256 individual services might be separately tracked for purposes of detecting some sort of attack. However, in cloud computing, there may be thousands or even tens of thousands of virtual services simultaneously instantiated for any number of customers in a given physical data center. Thus, the methodology described herein operates effectively even when a number of the plurality of customers being provided with virtual data center services is substantially greater than a number of individual assignable QoS levels.

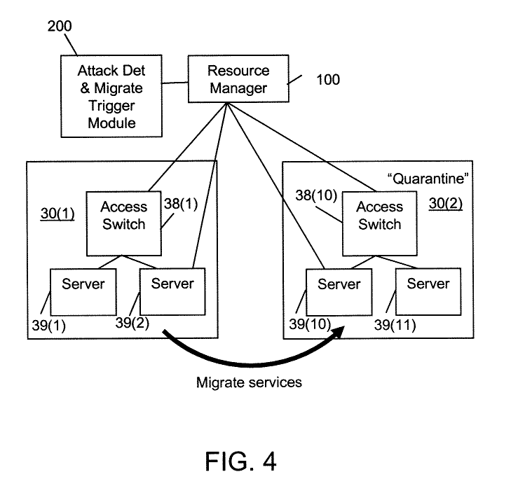

FIG. 4 shows a simplified version of FIG. 1 including migration of services from one POD of a data center to another POD of the data center, and in this case a “quarantine” POD. As shown in the figure, there is provided a Resource Manager 100 in communication with Attack Detector and Migration Trigger Module 200. Resource Manager 100 is in communication with elements of the PODs 30(1) and 30(2), where POD 30(2) is the designated quarantine POD. Servers 39(1) and 39(2) are accessible via Access Switch 38(1). Likewise, Servers 39(10) and 39(11) are accessible via Access Switch 38(10). Resource Manager 100 is in communication with elements of the PODs 30(1) and 30(2) (although for clarity, two of the servers in the figure are shown not connected with Resource Manager 100). When Attack Detector and Migration Trigger Module 200 determines that virtual data center services being supported by server 39(1) are being subjected to an attack, the Attack Detector and Migration Trigger Module 200 causes, by, e.g., sending appropriate signals to the Access Switches and Servers, those virtual data center services to be migrated to or instantiated on, server 39(10) as indicated by the curved arrow. Server 39(10) is served by a different Access Switch 38(10) than server 38(1).

In this way, the virtualized services remaining in, e.g., POD 30(1) may no longer be detrimentally impacted by, e.g., the overuse of resources by the services that have now been migrated.

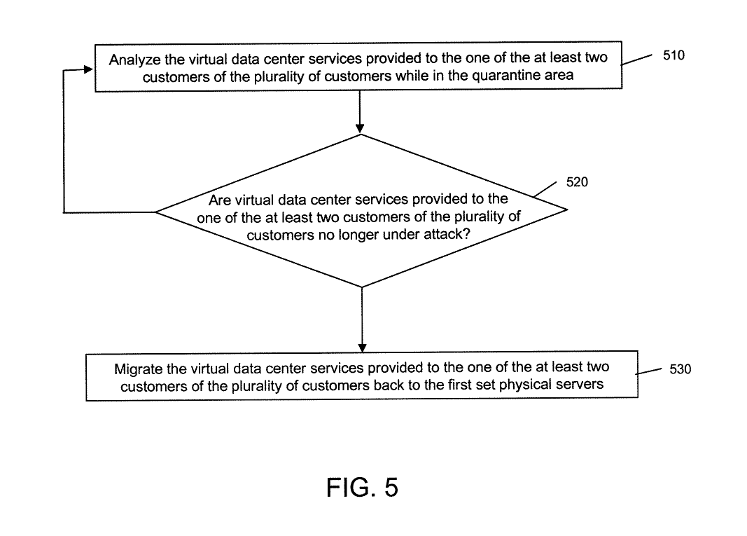

Reference is now made to FIG. 5, which depicts another set of operations that may be performed by Attack Detection and Migration Trigger Module 200, after the affected (e.g., attacked) services have been migrated. At 510, the methodology provides for analyzing the virtual data center services provided to the one of the at least two customers of the plurality of customers while in the quarantine area to determine if the services are still under attack or are sufficiently safe to be removed from the quarantine area. At 520 it is formally determined whether virtual data center services are no longer under attack. If no, i.e., the services are still under attack, then the process returns to 510 for further analysis. If the virtual data center services are no longer under attack, then the method proceeds to 530 in which the methodology is configured to migrate the virtual data center services provided to the one of the at least two customers of the plurality of customers back to the first set of physical servers or some other hardware outside of the quarantine area. Referring again to FIG. 4, the arrow depicting migration would, in the case where services are being migrated back, point in the opposite direction.

Thus, as those skilled in the art will appreciate, the methodology and supporting hardware described herein is configured to automatically detect when services being provided to a customer or tenant of a virtual data center are under attack (by way of, e.g., a virus, a denial of service attack, etc.). The methodology is then further configured to determine whether such an attack might cause inadvertent denial of service (or loss in quality of service) to other customers or tenants being supplied with virtualized services and, when that is the case, the methodology is configured to automatically take mitigating efforts to reduce or eliminate the impact of the attack on those other customers and tenants. Those efforts might include triggering a Resource Manager to migrate the attacked services to an isolated area of the physical data center such that, e.g., network traffic that has been unexpectedly increased as a result of the attack will not degrade the service to other virtualized services that may be sharing some or all of the same physical hardware.

Although the discussion herein focused on attacks that might emanate from outside of the physical data center, those skilled in the art will also appreciate that an attack that is generated within the data center can also be addressed using the methodology described herein, especially to the extent that any such attack causes an increase in network traffic through an access switch (or some other device) on which an instance of Attack Detection and Migration Trigger Module 200 might be running. That is, some form of malware might be surreptitiously loaded onto one of the virtual machines running on one of the servers 39. Attack Detection and Migration Trigger Module 200 might be able to detect such malware directly (by, e.g., running an anti-virus application on all virtual machines), or as a result of an increase in traffic through a given hardware device. Either way, a trigger can still be transmitted to Resource Manger 100 to effect migration of the virtual machine suspected of being under attack.

The above description is intended by way of example only.

What is claimed is:

1. A method comprising:
detecting that virtual data center services provided to one of the at least two customers of are being subjected to an attack, wherein the virtual data center services are provided to the least two customers using a same first set of physical servers via a first network element; and
responsive to detecting that virtual data center services provided to the one of the at least two customers are being subjected to an attack, causing the virtual data center services provided to the one of the at least two customers to be migrated to a second set of physical servers that is not accessible via the first network element.

2. The method of claim 1, further comprising detecting, at the first network element, that the virtual data center services are being subjected to the attack.

3. The method of claim 1, further comprising detecting that the attack is a denial of service attack.

4. The method of claim 1, further comprising designating a quarantine area within the physical data center and causing the virtual data center services provided to the one of the at least two customers to be migrated to the quarantine area.

5. The method of claim 4, further comprising analyzing the virtual data center services provided to the one of the at least two customers while in the quarantine area, and migrating the virtual data center services provided to the one of the at least two customers back to the first set physical servers when it is determined that the virtual data center services provided to the one of the at least two customers are no longer under attack.

6. The method of claim 1, wherein causing the virtual data center services provided to the one of the at least two customers to be migrated is initiated when the attack is impacting virtual data center services being provided to the other one of the at least two customers.

7. The method of claim 1, further comprising controlling a resource manager that controls an allocation of the physical servers for the virtual data center services to cause the virtual data center services provided to the one of the at least two customers to be migrated to the second set of physical servers that is not accessible via the first network element.

8. The method of claim 1, further comprising providing virtual data center services to a plurality of customers, wherein a number of the plurality of customers being provided with virtual data center services is substantially greater than a number of individual assignable quality of service levels.

9. The method of claim 1, further comprising detecting that the attack is emanating from outside of the physical data center.

10. A computer-readable memory medium storing instructions that, when executed by a processor, cause the processor to:
detect that virtual data center services provided to one of at least two customers are being subjected to an attack, wherein the virtual data center services are provided to the least two customers using a same first set of physical servers via a first network element; and
responsive to detecting that the virtual data center services provided to the one of the at least two customers are being subjected to an attack, cause the virtual data center services provided to the one of the at least two customers to be migrated to a second set of physical servers that is not accessible via the first network element.

11. The computer-readable memory medium of claim 10, wherein the instructions that cause the processor to detect that virtual data center services provided to one of at least two customers are being subjected to an attack cause the processor to detect that the attack is a denial of service attack.

12. The computer-readable memory medium of claim 10, wherein the instructions are further configured to designate a quarantine area within the physical data center and to cause the virtual data center services provided to the one of the at least two customers to be migrated to the quarantine area.

13. The computer-readable memory medium of claim 12, wherein the instructions are configured to analyze the virtual data center services provided to the one of the at least two customers while in the quarantine area, and to cause the virtual data center services provided to the one of the at least two customers to be migrated back to the first set physical servers when it is determined that the virtual data center services provided to the one of the at least two customers are no longer under attack.

14. The computer-readable memory medium of claim 10, wherein the instructions are configured to cause the virtual data center services provided to the one of the at least two customers to be migrated when the attack is impacting virtual data center services being provided to the other one of the at least two customers.

15. The computer-readable memory medium of claim 10, wherein the instructions are configured to control a resource manager that controls an allocation of the physical servers for the virtual data center services to cause the virtual data center services provided to the one of the at least two customers to be migrated to a second set of physical servers that is not accessible via the first network element.

16. An apparatus comprising:
a network interface unit configured to communications over a network with at least a resource manager; and
a processor circuit configured to be coupled to the network interface unit, wherein the processor is configured to:
detect that virtual data center services provided to one of at least two customers are being subjected to an attack, wherein the virtual data center services are provided to the least two customers using a same first set of physical servers via a first network element; and
responsive to detecting that virtual data center services provided to the one of the at least two customers are being subjected to an attack, cause, via the network interface unit communicating with the resource manager, the virtual data center services provided to the one of the at least two customers to be migrated to a second set of physical servers that is not accessible via the first network element.

17. The apparatus of claim 16, wherein the processor circuit is configured to designate a quarantine area within the physical data center and to cause the virtual data center services provided to the one of the at least two customers to be migrated to the quarantine area.

18. The apparatus of claim 17, wherein the processor circuit is configured to analyze the virtual data center services provided to the one of the at least two customers while in the quarantine area, and to cause the virtual data center services provided to the one of the at least two customers to be migrated back to the first set physical servers when it is determined that the virtual data center services provided to the one of the at least two customers are no longer under attack.

19. The apparatus of claim 16, wherein the processor circuit is configured to cause the virtual data center services provided to the one of the at least two customers to be migrated when the attack is impacting virtual data center services being provided to the other one of the at least two customers.

20. The apparatus of claim 16, wherein the processor circuit is configured to detect that the attack is emanating from outside of the physical data center.
